(19) United States
(12) Patent Application Publication
(10) Pub. No.: US 2022/0306381 A1
(43) Pub. Date: Sep. 29, 2022

(54) SYSTEM AND METHOD FOR A SELF-CLEANING OUTDOOR GARBAGE CAN

(71) Applicants: Verdi Antonio Cedeno, Apex, NC (US); Elizabeth Perez Valdovinos, Apex, NC (US)

(72) Inventors: Verdi Antonio Cedeno, Apex, NC (US); Elizabeth Perez Valdovinos, Apex, NC (US)

(21) Appl. No.: 17/213,380

(22) Filed: Mar. 26, 2021

(51) Int. Cl. B65F 7/00; B65F 1/04; B65F 1/16; B08B 9/08

(52) U.S. Cl. CPC B65F 7/00; B65F 1/04; B65F 1/16; B08B 9/0813; B08B 2209/08

(57) ABSTRACT

A system and method for a self-cleaning outdoor garbage can having a pivoting attached lid with an oscillating or rotating water sprayer attached to the inside of the lid, allowing the water sprayer to clean the interior of the garbage can without an individual having to be present or attend to the cleaning process.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a garbage can with a self-cleaning feature.

### Description of Related Art

The use of plastic garbage cans with attached lids has become ubiquitous. They have been found to be useful in both home and commercial applications because both generate a lot of garbage. Large outdoor garbage cans are mostly in the 30-125 gallon size and have attached lids. They are typically designed to receive garbage from smaller garbage cans as the final stop before city or county garbage collection or before being taken to a disposal facility. Because these large outdoor garbage cans store items for disposal from various sources, they get very dirty on the inside and require frequent cleaning to help prevent deterioration of the can and to reduce off putting odors.

The current way of cleaning the interior of an outdoor garbage can is to either tip the garbage can and use a hose to hand rinse out the garbage can or invert the garbage can over a water source. While this works, it creates a mess since water tends to get all over the area that is being cleaned and the material being washed out ends up on the ground. In addition, the time it takes to hand wash which makes it a very cost inefficient endeavor.

### BRIEF SUMMARY OF THE INVENTION

The present invention relates to the discovery that an oscillating or rotating spray head can be attached to the inside of the lid of the garbage can, allowing the user to walk away until the sprayer is finished. In addition, since the water is contained in the garbage can, it can be disposed of without an individual getting dirty or getting water everywhere.

Accordingly, in one embodiment, there is a self-cleaning outdoor garbage can system comprising:
a) an outdoor garbage can that has a volume of at least 30 gallons and having a pivoting attached lid;
b) an oscillating or rotating sprayer attached to an inside of the pivoting attached lid and connected to a water supply; and
c) a water supply.

In another embodiment, there is a method of cleaning an outdoor garbage can comprising:
a) selecting an outdoor garbage can that has a volume of at least 30 gallons and having a pivoting attached lid;
b) attaching an oscillating or rotating sprayer to an inside of the pivoting attached lid and connecting it to a water supply;
c) turning the water supply on so that the oscillating or rotating sprayer starts spraying water to the sides and bottom of the interior of the outdoor garbage can;
d) turning the water supply off when either the outdoor garbage can is clean or automatically after a specific amount of time passes; and
e) emptying the accumulated water in the outdoor garbage can.

### BRIEF DESCRIPTION OF THE DRAWINGS

FIG. 1 is a front perspective view of the system of the present invention with the outdoor garbage can lid open to show the sprayer.

FIG. 2 is a see through perspective showing the washing process of the system of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “self-cleaning” refers to the situation where a rotating or oscillating water sprayer is utilized and does the work of cleaning the inside of the garbage can without the need for an operator to hold a hose or scrub the inside of the outdoor garbage can.

As used herein, the term “outdoor garbage can system” refers to the combination of an outdoor garbage can with a rotating or oscillating water sprayer mounted (permanently or removably) on the lid bottom. In addition, the sprayer will have a water connection that can be attached when it's time to clean the outdoor garbage can. In one embodiment, the attachment is via a water hose.

As used herein, the term “outdoor garbage can” refers to the 30 gallon or greater garbage cans with a pivoting attached lid. While these outdoor garbage cans can be utilized indoors, they are primarily designed for use as outside garbage cans. While it is not necessary for the present invention, many outdoor garbage cans include at least two wheels to facilitate moving the garbage can. The lid has a top outside and a bottom that faces the inside of the can when the lid is closed.

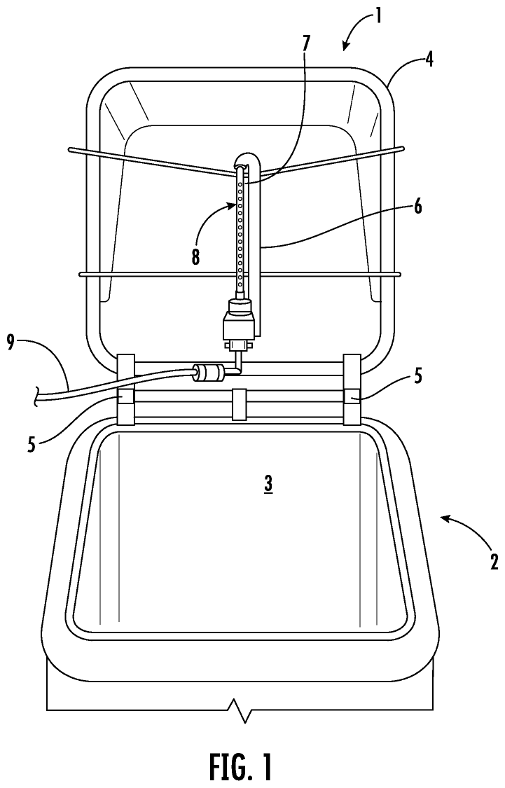

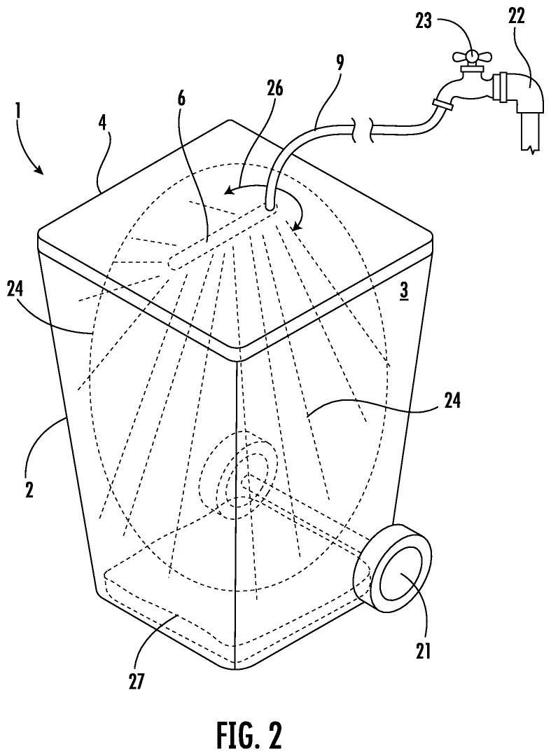

As used herein, the term “pivoting attached lid” refers to an outdoor garbage can lid that is attached to one side of the top perimeter of the outdoor garbage can, for example as shown in FIGS. 1 and 2.

As used herein, the term “connected to a water supply” refers to a water hose or other water connecting means that is attached in fluid communication with the pivoting or oscillating water sprayer.

As used herein, the term “turning the water supply on” refers to initiating flow of water from the water supply to the oscillating or pivoting water sprayer. In one embodiment, the valve of the water supply is engaged to an open position.

As used herein, the term “oscillating or rotating sprayer” refers to water sprayers that either work by a series of holes in a tube spraying water while moving back and forth or a sprayer which rotates circularly to spray around the interior of the outdoor garbage can. In one embodiment, the sprayer can automatically change position to ensure the entire inside of the outdoor garbage can has been cleaned.

As used herein, the term “inside the pivoting lid” refers to placement of the oscillating or rotating sprayer on the inside bottom of the pivoting lid.

As used herein, the term “water supply” refers to any source of water that is strong enough to power the oscillating or rotating sprayer sufficiently to clean the interior of the outdoor garbage can.

As used herein, the term “clean” refers to the sprayer washing the inside of the outdoor garbage can and then dumping the dirty water out. In some cases, if the outdoor garbage can is extremely dirty, it may take repeating the wash/dump cycle.

As used herein, the term “specific time” refers to the oscillating or rotating sprayer being able to automatically turn off after a selected time period, for example 10 minutes.

As used herein, the term “accumulated water” refers to the water that collects inside of the outdoor garbage can during the cleaning process.

In use, the garbage can sprayer is connected to a water source, the lid closed, and the water turned on for a period of time until the interior of the garbage can is clean. The accumulated water is then dumped out in a manner that doesn't allow water to get all over the floor. For example, it is poured out of the receptacle portion of the outdoor garbage can into a drain.

### DRAWINGS

Now referring to the drawings, FIG. 1 is a frontal perspective of the outdoor garbage can system 1. The outdoor garbage can system 1 consists of a 50 gallon outdoor garbage can 2, which has a receptacle portion 3 for the placing of garbage and a pivoting attached lid 4 having pivot hinges 5 connected to outdoor garbage can 2 in order to pivot on pivot hinges 5.

On the inside of the pivoting attached lid 4 is an attached water sprayer 6. In one embodiment, there is an oscillating sprayer that allows the spray arm 7 to move back and forth. In this embodiment specifically, the spray arm moves left and right spraying water from holes 8. There is a water hose 9 in fluid connection to one end of the oscillating sprayer. By closing the pivoting attached lid 4 and turning on the water supply to the water hose 9, the spray arm 7 moves left and right cleaning the receptacle portion 3 of the outdoor garbage can 2.

In FIG. 2, we see the entire outdoor garbage can 2. The outdoor garbage can 2 is being washed by spray 24 from water sprayer 6 moving left and right 26. In this view, we can see wheels 21, a water spigot 22 with on/off handle 23. Water 27 is collecting in the receptacle portion 3, which is later dumped out in an appropriate place.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A self-cleaning outdoor garbage can system comprising:
a) an outdoor garbage can that has a volume of at least 30 gallons and having a pivoting attached lid;
b) an oscillating or rotating sprayer attached to an inside of the pivoting attached lid and connected to a water supply; and
c) a water supply.

2. The self-cleaning outdoor garbage can system according to claim 1, wherein the oscillating or rotating sprayer is detachable from the inside of the pivoting attached lid.

3. The self-cleaning outdoor garbage can system according to claim 1, wherein the water supply is connected to the oscillating or rotating sprayer via a hose.

4. A method of cleaning an outdoor garbage can comprising:
a) selecting an outdoor garbage can that has a volume of at least 30 gallons and having a pivoting attached lid;
b) attaching an oscillating or rotating sprayer to an inside of the pivoting attached lid and connecting it to a water supply;
c) turning the water supply on so that the oscillating or rotating sprayer starts spraying water to the sides and bottom of the interior of the outdoor garbage can;
d) turning the water supply off when either the outdoor garbage can is clean or automatically after a specific amount of time; and
e) emptying the accumulated water in the outdoor garbage can.
